(19) United States
(12) Patent Application Publication
(10) Pub. No.: US 2012/0293948 A1
(43) Pub. Date: Nov. 22, 2012

(54) BASE FOR HARD DISK DRIVE AND HARD DISK DRIVE HAVING THE SAME

(75) Inventors: Il Geun JEON, Suwon (KR); Tae Young CHOI, Suwon (KR)

(73) Assignee: SAMSUNG ELECTRO-MECHANICS CO., LTD., Gyunggi-do (KR)

(21) Appl. No.: 13/475,817

(22) Filed: May 18, 2012

(30) Foreign Application Priority Data
May 20, 2011 (KR) 10-2011-0048087
Apr. 3, 2012 (KR) 10-2012-0034559

(51) Int. Cl. G06F 1/16

(52) U.S. Cl. 361/679.33

(57) ABSTRACT

Disclosed herein is a base for a hard disk drive, including: a base plate; and a side joining part formed on one side of the base plate, the side joining part including a joining hole for screw fastening, wherein the side joining part includes: a joining side spaced apart from one side of the base plate and provided with the joining hole; and side wall surfaces formed by bending both side ends of the joining side. In accordance with a preferred embodiment of the present invention, rigidity of the base can be increased by bending both side ends of the joining side of the side joining part of the base plate.

### CROSS REFERENCE TO RELATED APPLICATION

This application claims the benefit of Korean Patent Application No. 10-2011-0048087, filed on May 20, 2011, entitled “Hard Disk Drive”, Korean Patent Application No. 10-2012-0034559, filed on Apr. 3, 2012, entitled “Base For Hardisk Drive And Hard Disk Drive Having The Same”, which are hereby incorporated by reference in its entirety into this application.

### BACKGROUND OF THE INVENTION

1. Technical Field

The present invention relates to a base for a hard disk drive and a hard disk drive having the same.

2. Description of the Related Art

Generally, a spindle motor, which belongs to a brushless-DC motor (BLDC), has been widely used as a laser beam scanner motor for a laser printer, a motor for a floppy disk drive (FDD), a motor for an optical disk drive such as a compact disk (CD) or a digital versatile disk (DVD), or the like, in addition to a motor for a hard disk drive.

In particular, a base used for a hard disk drive is mounted with the spindle motor as described above, forms an appearance thereof, and is connected to a printed circuit board. The hard disk drive is connected to a personal computer by a connector of the printed circuit board. Generally, the base is manufactured by manufacturing an aluminum material by a die-casting method and performing additionally detailed machining However, manufacturing the base using the die-casting method leads to an increase in lead time of production, such that productivity may be degraded and a process may be complicated and troublesome due to separate processes added after the die-casting. Therefore, in order to solve the problems, there is a need to manufacture the base by a press machining method in consideration of quality and productivity of a product.

However, when manufacturing the base by a press method, it is impossible to manufacture the base above a thickness of a steel plate, or the like, used for press machining Therefore, rigidity of a portion of one side of the base with which a screw is fastened may be degraded. In addition, even in the case of an HDD base structure directly fastened with a personal computer (PC) with a screw, it is difficult to maintain rigidity of screw fastening.

### SUMMARY OF THE INVENTION

The present invention has been made in an effort to provide a hard disk drive capable of strengthening rigidity of a base and improving fastening force of screw fastening by a structural change of a side joining part for screw fastening of a base.

According to a preferred embodiment of the present invention, there is provided a base for a hard disk drive, including: a base plate; and a side joining part formed on one side of the base plate, the side joining part including a joining hole for screw fastening, wherein the side joining part includes: a joining side spaced apart from one side of the base plate and provided with the joining hole; and side wall surfaces formed by bending both side ends of the joining side.

The side wall surface may be bent so as to be tapered so that a width thereof gradually extends from both side ends of the joining surface.

The joining hole may be formed on the joining surface and a hole wall surface formed with the joining hole may be protruded so as to extend the joining hole inwardly of the joining surface.

The base for a hard disk drive may further include: a rear joining part corresponding to a rear of the base plate and extending to one side of the side joining part, wherein the rear joining part includes: a joining rear formed with a joining hole to which a screw is fastened; and a hole wall surface protruded so that the joining hole extends inwardly of the joining rear.

The base may be manufactured by a press machining method.

The hole wall surface may extend longer than a length of a thickness of the joining side.

The hole wall surface may extend longer than a length of a thickness of the joining rear.

The side wall surfaces may be formed by vertically bending both side ends of the joining side, respectively, in one side direction of the base plate.

The base for a hard disk drive may further include: a joining rear extending from one end of the joining side and bent in a rear direction of the base plate.

The joining rear may be vertically bent from one end of the joining side.

According to another preferred embodiment of the present invention, there is provided a hard disk drive, including the base for a hard disk drive as described above.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view of a base in accordance with a preferred embodiment of the present invention;

FIG. 2 is a front perspective view of a side joining part in accordance with the preferred embodiment of the present invention;

FIG. 3 is a rear perspective view of a side joining part of the base in accordance with the preferred embodiment of the present invention;

FIG. 4 is a cross-sectional view taken along line A-A′ of FIG. 2;

FIG. 5 is a cross-sectional view of a rear joining part of a base in accordance with the embodiment of the present invention;

FIG. 6 is a front perspective view of a side joining part of the base in accordance with another preferred embodiment of the present invention; and

FIG. 7 is a rear perspective view of the base in accordance with another preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

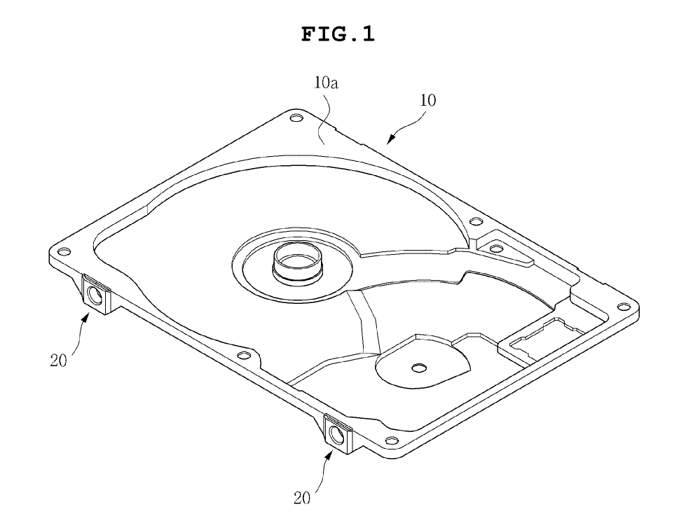

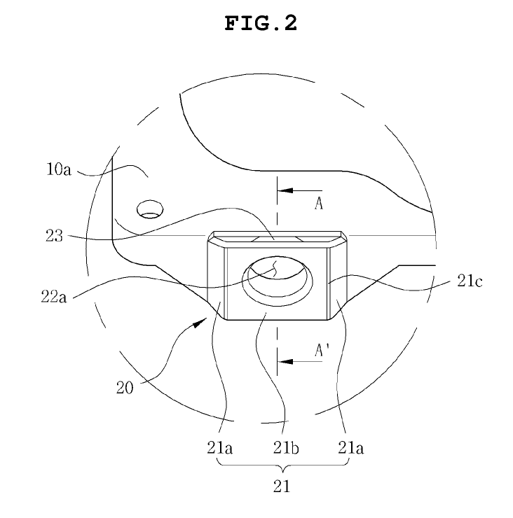

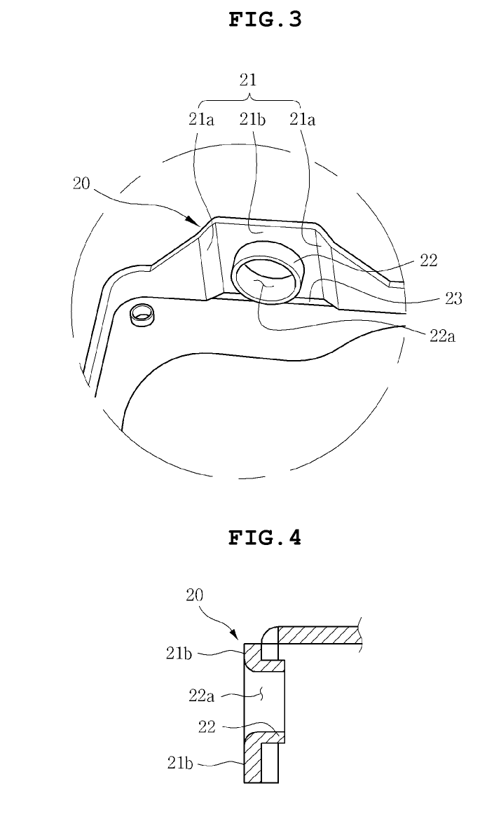

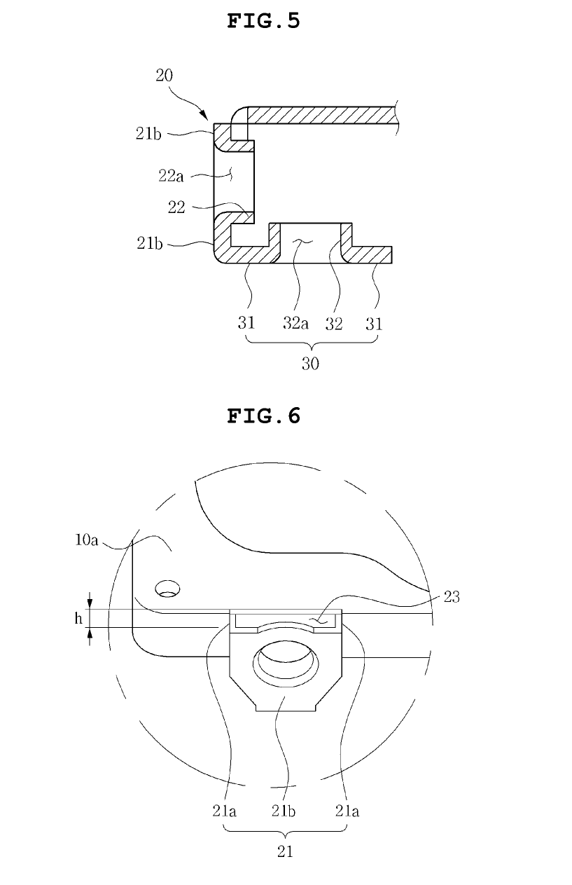

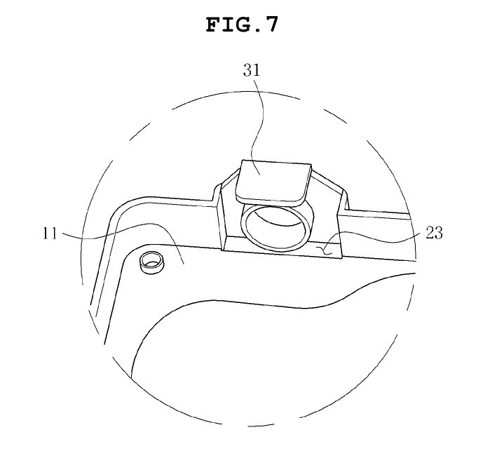

FIG. 1 is a perspective view of a base in accordance with a preferred embodiment of the present invention, FIG. 2 is a front perspective view of a side joining part in accordance with the preferred embodiment of the present invention, FIG. 3 is a rear perspective view of a side joining part of the base in accordance with the preferred embodiment of the present invention, FIG. 4 is a cross-sectional view taken along line A-A′ of FIG. 2, FIG. 5 is a cross-sectional view of a rear joining part of a base in accordance with the embodiment of the present invention, FIG. 6 is a front perspective view of a side joining part of the base in accordance with another preferred embodiment of the present invention, and FIG. 7 is a perspective view showing a rear perspective view of the base in accordance with another preferred embodiment of the present invention.

A base 10 for a hard disk drive in accordance with the preferred embodiment of the present invention includes a base plate 10a and a side joining part 20 including a joining hole 22a for screwing that is formed on one side of the base plate 10a, wherein the side joining part 20 includes a joining side 21b spaced apart from one side of the base plate 10a and provided with the joining hole 22a and side wall surfaces 21a formed by bending both side ends of the joining side 21b.

The base plate 10a forms an appearance of various parts such as a spindle motor, head assembly (not shown), or the like, of a hard disk drive and may be joined with a cover member (not shown) and then, may be fastened with a personal computer, or the like. In addition, one surface of the base plate 10a is provided with a printed circuit board (not shown) and is generally used by being electrically connected with the outside. Herein, the base plate 10a may be variously made of aluminum, an aluminum alloy material, a steel plate, or the like. Further, the base 10 for a hard disk drive including the base plate 10a may be manufactured by a press machining method. As the base 10 is manufactured by the press machining, a lead time of production is saved, mass production is facilitated, and productivity can be improved by removing additionally separate machining processes. In addition, a process is simple such that production cost can be saved and quality of a final product can be improved. Herein, although the embodiment of the base 10 for a hard disk drive is mainly described, it is apparent to those skilled in the art that a base for various kinds of disk drives such as an optical disk drive, or the like, in addition to the hard disk drive may be selected and used.

The side joining part 20 is formed on one side of the base plate 10a. The side joining part 20 is a part at which the hard disk drive is screw-fastened to a personal computer (PC), or the like. The joining method is not particularly limited. Therefore, a structure of strengthening fastening force and increasing rigidity of the base plate 10a by a screw fastening method will be described herein. The side joining part 20 includes the joining side 21b formed on one side of the base plate 10a while forming a space 23 therebetween and the side wall surfaces 21a for supporting the joining side 21b formed on both side ends of the joining surface 21 at a spaced space 23. The side wall surface 21a may be formed by bending both side ends of the joining side 21b. The bending is made in a range of about 90° and thus, the side wall surfaces 21a are formed so that a width thereof gradually extends in a bending direction from both sides of the joining side 21b, thereby making it possible to increase the rigidity. However, the bending degree is not necessarily limited thereto and therefore, the bending may be made at various angles within a range of about 90°. In particular, as shown in FIG. 6, both side ends of the joining side 21b may be vertically bent at 90° in one side direction of the base plate 10a. In this case, the joining side 21b performs a control such as making a spaced height h from one side of the base plate 10a higher, or the like, thereby making it possible to increase the rigidity of the side joining part 20. In order to prevent tensile strain at the bent portion of the joining side 21b when bending both side ends of the joining side 21b, a cutting part 21c is previously formed at the bent portion to prevent the joining surface 21 from being deformed due to the bending. That is, in FIG. 2, the cutting part 21c may be formed at a boundary portion between the joining side 21b and both side wall surfaces 21a. The side joining part 20 may be simultaneously formed when the base plate 10a is manufactured by the press machining method and may be made of the same material.

The joining hole 22a for the screw fastening is formed on the joining side 21a. The joining hole 22a can be appropriately changed in design according to a shape of a fastening screw. Herein, the case in which the joining hole 22a is generally fastened by a cylindrical screw will be described. However, it is apparent to those skilled in the art that the joining hole 22a may be formed in a cylindrical shape and a polygonal shape. The joining hole 22a may further extend inwardly of the joining surface in order to further improve the fastening force with the screw. That is, a cylindrical hole wall surface 22 is protruded inwardly of the joining side 21b. The cylindrical hole wall surface 22 extends inwardly of the joining side 21b and thus, a fastening length of the screw is long. Therefore, the fastening force is strengthened and the rigidity of the base plate 10a is strengthened. Herein, the length of the joining hole 22a extending inwardly of the joining surface 21 extends longer than a length in a thickness direction of the joining side 21b, thereby making it possible to increase the rigidity. As a result, the fastening force by the screw fastening at a portion that has no choice but to be thinly formed by the press machining and the rigidity of the base plate 10a can be increased. The hall wall surface 22 may be formed by a method of boring a foundation hole on the joining side 21a and then, roundly rolling the joining side 21a inwardly.

The base plate 10a may be further provided with a rear joining part 30 in addition to the side joining part 20. The rear joining part 30 includes a joining rear 31 formed with a joining hole 32a to which a screw is fastened and a hole wall surface 32 formed to be protruded so that the joining hole 32a extends inwardly of the joining rear 31. The joining surface 31 may extend in a rear 11 direction of the base plate from one end of the side joining part 20 and may be bent in the rear 11 direction of the base plate 10a. Similar to the side joining part 20, the rear joining part 30 may increase the strengthening of the screw fastening force and the rigidity of the base plate 10a by extending the joining hole 32a inwardly of the joining surface to form the hole wall surface 32. The rear joining part 30 may be simultaneously manufactured when the base plate 10a is manufactured by the press machining. In particular, as shown in FIG. 7, the joining rear 31 of the rear joining part 30 may be bent in the rear 11 direction of the base plate 10a without forming the joining hole 32a. Therefore, the joining surface 31 serves as a seating surface of the hard disk drive. When the joining rear 31 is bent in the rear 11 direction of the base, the joining rear 31 may be bent in a range of about 90° from one end of the joining side 21b and as shown in FIG. 7, may be vertically bent.

A description of components overlapping with other side joining parts 20 will be omitted and the machining of the hole wall surface 32 may also be formed by a method similar to the method of forming the hole wall surface 22 of the side joining part 20.

According to the preferred embodiments of the present invention, the rigidity of the base can be increased by bending both side ends of the joining side of the side joining part of the base plate.

In addition, the joining side of the side joining part is formed to have the higher spaced height from one side surface of the base and the side part is formed by vertically bending both side ends of the joining side in one side direction of the base, thereby making it possible to increase the rigidity of the side joining part.

Further, the joining side of the side joining part is spaced apart from one side of the base plate and both sides of the joining side are bent at a predetermined angle so that the width between both side wall surfaces extends toward one side direction of the base plate, thereby making it possible to improve the rigidity of the side joining part.

Moreover, the cylindrical side wall part is formed on the joining surface of the side joining part and is formed by extending the joining hole formed so as to be fastened with the screw inwardly of the joining surface, thereby making it possible to increase the rigidity of the base including the base plate and the fastening force of the screw fastening.

Also, the rear joining part extending from one side end of the side joining part and formed in the rear direction of the base plate is further formed and the joining hole fastened with the screw inwardly of the joining surface of the rear joining part is extendedly formed, thereby making it possible to increase the fastening force of the rear joining part while fastening the side of the base plate with the rear of the base plate.

Also, the joining rear structure bent in the rear direction of the base plate from one end of the joining side of the side joining part can improve the rigidity of the outside of the base plate and can serve as the seating surface of the base.

Further, the side joining part and the rear joining part of the base plate are manufactured by the press machining, thereby making it possible to improve the productivity of the base including the base plate and increase the quality of the base.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A base for a hard disk drive, comprising:
a base plate; and
a side joining part formed on one side of the base plate, the side joining part including a joining hole for screw fastening;
wherein the side joining part includes:
a joining side spaced apart from one side of the base plate and provided with the joining hole; and
to side wall surfaces formed by bending both side ends of the joining side.

2. The base for a hard disk drive as set forth in claim 1, wherein the side wall surface is bent so as to be tapered so that a width thereof gradually extends from both side ends of the joining surface.

3. The base for a hard disk drive as set forth in claim 1, wherein the joining hole is formed on the joining surface and a hole wall surface formed with the joining hole is protruded so as to extend the joining hole inwardly of the joining surface.

4. The base for a hard disk drive as set forth in claim 1, further comprising a rear joining part corresponding to a rear of the base plate and extending to one side of the side joining part,
wherein the rear joining part includes:
a joining rear formed with a joining hole to which a screw is fastened; and
a hole wall surface protruded so that the joining hole extends inwardly of the joining rear.

5. The base for a hard disk drive as set forth in claim 1, wherein the base is manufactured by a press machining method.

6. The base for a hard disk drive as set forth in claim 3, wherein the hole wall surface extends longer than a length of a thickness of the joining side.

7. The base for a hard disk drive as set forth in claim 4, wherein the hole wall surface extends longer than a length of a thickness of the joining rear.

8. The base for a hard disk drive as set forth in claim 1, wherein the side wall surfaces are formed by vertically bending both side ends of the joining side, respectively, in one side direction of the base plate.

9. The base for a hard disk drive as set forth in claim 1, further comprising a joining rear extending from one end of the joining side and bent in a rear direction of the base plate.

10. The base for a hard disk drive as set forth in claim 9, wherein the joining rear is vertically bent from one end of the joining side.

11. A hard disk drive comprising the base for a hard disk drive as set forth in claim 1.
